(19) United States
(12) Patent Application Publication
(10) Pub. No.: US 2012/0290369 A1
(43) Pub. Date: Nov. 15, 2012

(54) REFERENDUM ENHANCED SUBSCRIPTION BASED APPLICATION SYSTEM

(76) Inventor: Jesus Acosta-Cazaubon, Atlanta, GA (US)

(21) Appl. No.: 13/325,018

(22) Filed: Dec. 13, 2011

Related U.S. Application Data
(63) Continuation-in-part of application No. 13/211,397, filed on Aug. 17, 2011.
(60) Provisional application No. 61/484,996, filed on May 11, 2011.

(51) Int. Cl. G06F 15/16; G06Q 30/02

(52) U.S. Cl. 705/14.4; 709/217

(57) ABSTRACT

The present invention is directed toward a system and method for conducting a referendum. The system comprises a subscription based application having a content and a referendum having at least one attribute wherein the at least one attribute is relevant to the content and the referendum is presented in close proximity to the content within the subscription based application.

### PRIORITY CLAIM AND RELATED APPLICATIONS

This continuation-in-part application claims the benefit of priority from provisional application U.S. Ser. No. 61/484,996 filed May 11, 2011 and non-provisional application U.S. Ser. No. 13/211,397 filed Aug. 17, 2011. Each of these applications is incorporated by reference in its entirety.

### BACKGROUND OF THE INVENTION

1. The Field of the Invention

The present invention is directed generally to a system and method for electronically and anonymously conducting and participating in a referendum served on a subscription based content.

2. Background Art

U.S. Pat. No. 7,813,963 discloses a method and system for increasing the yield of response to an electronic solicitation to take action by presenting direct action links within the solicitation itself. It was disclosed that these direct action links are distinguished by the ability to initiate a transaction when a user interacts with them. It was further disclosed that the enhanced program has the capability of storing information about the user of the system for authorizing future transactions. FIG. 1 of the '963 patent depicts a referendum interface for a transaction that does not maintain anonymity. In fact, column 6 lines 52-53 and column 8 lines 22-23 of '963 teach a referendum that is contrary in nature to the one of the benefits offered by the present invention, i.e., anonymity. The '963 patent discloses an interface that allows a user to enter email addresses of his/her friends such that they may receive and weigh in on the same referendum.

U.S. Pat. No. 6,175,833 discloses an online voting system which provides a standardized database architecture that integrates editorial and production processes. The voting system has a survey database to store multiple surveys and a server to serve the surveys over a network to readers. Column 7 lines 41 to 53 discloses a mechanism by which a request is identified, i.e., the GUID. As will be appreciated by those skilled in the art, a GUID is traceable to the computer which creates it.
“In the OSF-specified algorithm for generating new (V1) GUIDs, the user's network card MAC address is used as a base for the last group of GUID digits, which means, for example, that a document can be tracked back to the computer that created it.” http://en.wikipedia.org/wiki/Globally_unique_identifier

However, a mechanism which enables tracing may not be tolerated by users concerned by privacy issues. Therefore, such a mechanism fails to inspire confidence amongst would-be referendum takers and therefore lacks the appeal to attract referendum participation.

U.S. Pat Pub. No. 2007/0192179 discloses systems and methods for survey based qualification of keyword searches and survey based qualification of keyword advertising. A searcher provides a search query to a search engine and is presented with at least one query-specific survey question. The searcher's original query and/or response to the query-specific survey question(s) are then used to generate search results. Although the concept of utilizing a survey result for refining a search process is disclosed, this disclosure however does not teach a referendum system that is anonymous, simple to use and a system and method in which referendums are standardized to promote sharing of referendum data.

Thus, there arises a need for a referendum system and method that are truly anonymous and simple to use such that referendum participation can be improved. Further, there arises a need for a referendum system and method where disparate referendum systems may be combined to increase sample size for providing statistically reliable information.

### SUMMARY OF THE INVENTION

The present invention is directed toward a system and method for conducting a referendum, the system comprising:
(a) a subscription based application having a content; and
(b) a referendum having at least one attribute relevant to the content wherein the referendum is presented in close proximity to the content within the subscription based application.

In one embodiment, the system further comprises an advertisement banner served within the subscription based application. In another embodiment, the system further comprises a referendum statistics banner served within the client system. The subscription based application can include Really Simple Syndication (RSS), Internet Relay Chat (IRC) and microblogs.

Accordingly, it is a primary object of the present invention to provide a referendum system and method that is presented in a targeted area.

It is another object of the present invention to provide a referendum system that has a simple user interface and one that does not require an end user to navigate away from the user interface in order to respond to the referendum system.

Whereas there may be many embodiments of the present invention, each embodiment may meet one or more of the foregoing recited objects in any combination. It is not intended that each embodiment will necessarily meet each objective. Thus, having broadly outlined the more important features of the present invention in order that the detailed description thereof may be better understood, and that the present contribution to the art may be better appreciated, there are, of course, additional features of the present invention that will be described herein and will form a part of the subject matter of this specification.

### BRIEF DESCRIPTION OF THE DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a sequence diagram depicting the anonymous execution of a referendum using a hashed cookie (or token) according to the present invention.

FIG. 2 is a sequence diagram depicting the anonymous execution of a referendum using a hashed MAC address according to the present invention.

FIG. 2A depicts a mechanism where a token is used to indicate a client source and a hashed result is used to ensure the integrity of the transmission of a referendum answer from the client source.

FIG. 3 is a block diagram depicting prior art referendum pools maintained by disparate servers.

FIG. 4 is a block diagram of the present invention depicting a mechanism by which referendum pools of disparate servers are shared.

FIG. 5 is a block diagram of the present invention depicting referendum pools of disparate servers linked to an index pool server.

FIG. 5A is a block diagram of the present invention depicting a survey server that is linked to the index pool server of FIG. 5.

FIG. 6 is a sequence diagram depicting a synchronization process of a plurality of referendum pools.

FIG. 7 is a display depicting the presentation of a referendum on a subscription based application.

FIG. 8 is a display depicting the presentation of a referendum on a subscription based application.

### PARTS LIST

2—server
4—client1
6—client2
8—facilities available at client1
9—facilities available at client1 when hashed MAC address is used
10—facilities available at server
12—facilities available at client2
14—act of an administrator selecting a referendum
16—request for a setup interface of a referendum as identified by refID
18—transmission of a requested setup interface of a referendum as identified by refID
20—act of an administrator setting and executing one or more setup parameters including a switch for indicating whether multiple referendum results from a device should be considered (countOnce)
22—transmission of an updated setup interface of a referendum as identified by refID
24—act of an end user selecting a referendum
26—request for a referendum as identified by refID, geoID and/or one or more
keywords
27—determine a referendum to be sent from server to client
28—transmission of a requested referendum as identified by refID, geoID and/or one or more keywords
30—act of storing cookie in software program of end user
32—act of an end user answering a referendum question the first time
34—transmission of a referendum result as identified by hashed cookie
36—act of responding to a received referendum result
38—act of an end user answering a referendum question the second time
40—transmission of a referendum result as identified by hashed cookie
42—act of responding to a received referendum result
44, 46, 48—referendum pools A, B and C respectively
50—index pool server
52—request to take out a temporary referendum ID from index pool server
54—transmission of a temporary referendum ID from index pool server to a referendum pool requesting it
56—act of adding a temporary referendum ID to an external list of a referendum pool
58—act of determining if a referendum already exists in a global list
60—transmission of an existing referendum with refID
62—acts of deleting the referendum associated with the temporary referendum ID and adding existing referendum with refID in external list of referendums
64—acts of deleting the counterpart referendum associated with the temporary referendum ID in the local list of the requesting referendum pool and adding existing referendum with refID to the local list
66—act of adding a newly indexed referendum to the global list
68—broadcast of newly indexed referendum with refID
70—act of replacing the identifier of current referendum with refID in external list
72—act of adding new referendum of refID to external and local lists
74—request for a nonce from server
76—transmission of nonce from server to client
78—act of composing a response
80—transmission of response from client to server
82—act of processing response
84—transmission of token from server to client
86—survey server
88—set of criteria
90—subscription based content
92—article
94—advertisement banner
96—referendum banner
98—referendum statistics
100—subscription based content scroll bar
102—article scroll bar
104—link to advertiser
106—link to article at originating website

### PARTICULAR ADVANTAGES OF THE INVENTION

The present referendum system provides a system and method for anonymously submitting a referendum result to a server. The present referendum provides a client system for an end user, the client system having an interface which enables fetching and submission of a referendum at the same interface without directing the end user to a second interface. In one embodiment, the client system is a subscription based application which enjoys increased viewership as compared to untargeted presentation of information. The present referendum system also provides a server system which is configurable to avoid redundant referendum result entry from a client system. The present referendum system further provides a mechanism to cause sharing of information between disparate referendum pools possible, thereby increasing statistical sample size.

### DETAILED DESCRIPTION OF A PREFERRED EMBODIMENT

A referendum as used herein connotes a type of survey requiring selection of one out of two choices presented. As an example, when presented with a question:

Referendum 1: “Do you drink Coca-cola in the morning?

Choice 1: Yes.

Choice 2: No.

A respondent to this referendum is expected to select a choice of either “Yes” or “No.” A survey on the other hand can be viewed as a superset of referendums. For example, a combination of referendums may constitute a survey. A survey question covering the above referendum may resemble the following:

Survey: Do you drink Coca-cola during the day?

Choice 1: Yes, in the morning.

Choice 2: Yes, in the afternoon.

Choice 3: No, not during the day.

As compared to the survey, had the answer to the above example referendum been Choice 1: Yes, there is still the ambiguity of whether the referendum taker drinks Coca-cola in the afternoon. If the answer had been Choice 2: No, the question of whether the referendum taker drinks Coca-cola in the afternoon remains unanswered. However, had there been another referendum as follows used in conjunction with the earlier referendum, the combined outcomes of the referendums would have been equivalent to the answer to the survey.

Referendum 2: “Do you drink Coca-cola in the afternoon?

Choice 1: Yes.

Choice 2: No.

If Referendums 1 and 2 both return the answers of Choice 2, then the answers are logically equivalent to Choice 3 of the survey question. The answers of Referendum 1 and Referendum 2 mirror Choices 1 and 2 of the survey question respectively. Although Referendums 1 and 2 may or may be presented as a group simultaneously, for statistical purposes, the answer to the survey question can be deduced from the answers to Referendums 1 and 2 taken as a whole. Therefore, although the present referendum system is designed to be simple and non-intrusive, as will be described elsewhere herein, surveys of increased sophistication can be deduced from referendums. Further, as will also be described herein, the present referendum system provides a means for standardizing referendums so that referendum servers of various sources can be synchronized to increase statistical sample size. As referendums represent surveys in their most basic form, the ease with which referendums are synchronized is increased.

A “user” as applied herein, defines a person who responds to a referendum, a respondent, a person who administers, designs, controls a referendum or receives results of a referendum or an administrator.

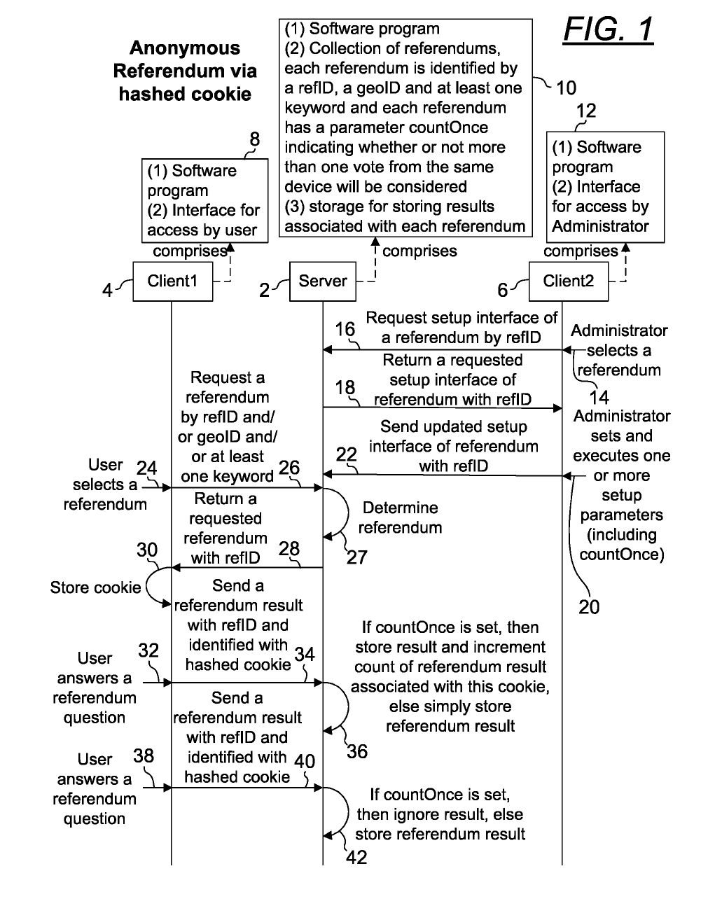

FIG. 1 is a sequence diagram depicting the anonymous execution of a referendum using a hashed cookie according to the present invention. For completeness, an anonymous referendum concept is shown with a server and two clients, i.e., client1 4 and client2 6. Client1 4 represents an end user while client2 6 represents a referendum provider or administrator. Although a referendum provider may also be shown as part of the server 2, it is more succinctly shown as a separate entity which is both logically and physically separated from the server 2. Client1 4 includes a software program, for example, a web browser, a website, a software program other than a web browser or a website and an interface for access by an end user as shown in block 8. In the context of a web browser or a website, any information entered within the web browser is received and processed either by the web browser, the website or both. If a web browser is used, the present referendum system embodies a plug-in application of the web browser which returns referendums based on keywords entered within a website served by the web browser. In this instance, a linkage is provided between the web browser and any information entered in any website served by the web browser such that any information entered in a website can be obtained by the web browser. If a website is used, the present referendum system embodies an area on the website which receives any information entered in response to one or more referendums served at any one time. Similar to client1, client2 also comprises a software program and an interface as shown in block 12. Server 2 comprises a software program, a collection of referendums received either via communication from client2 6 or directly through an upload process (not shown) local to the server 2 and a storage associated with each referendum. In use, the software program of the server, the collection of referendums and the storage may be implemented as a database. Each referendum is identified by a reference identifier refID, a geolocation identifiers geoID, at least one keyword and includes a parameter indicating whether or not more than one vote from the same end user device will be considered. Each geoID is associated with a geographical area linked for instance by a postal code, range of Internet Protocol (IP) addresses assigned by Internet Service Providers (ISP) or certain Global Positioning System GPS location. Before a referendum may be used, one or more of its parameters must be set.

An administrator first selects a referendum he/she desires to set up (step 14). The interface of the software program of client2 receives this request and its software program transmits this request for a setup interface of a referendum as identified by a refID (step 16). The software program of the server 2 receives this request, performs a lookup of a referendum identified by refID and transmits a setup interface associated with this refID to client2 (step 18). The setup interface includes a means by which a parameter called countOnce is set. The parameter countOnce specifies whether or not multiple referendum results from a unique client should be considered. If countOnce is set, only one referendum result from a unique client will be considered. Otherwise, all referendum results from a unique user client will be tallied. The provider then sets and executes one or more parameters on the setup interface (step 20). The updated setup interface is then transmitted to the server (step 22). Upon setting up countOnce, the present referendum system is ready for use. Setup is performed only once for each referendum until new parameters are desired. If new parameters are desired, the aforementioned process is again invoked and completed. Alternatively, all referendums may be configured with most commonly used or preferred default parameters at upload to avoid running the aforementioned setup procedure.

An end user may then make a selection of a referendum through an interface of a software program (step 24). An interface can take many forms, for instance web browser, internet search engine, online newspaper, browser-controlled environment (e.g. Java applet), an interface coded in browser-supported language (e.g. Javascript) combined with a browser-rendered markup language such as HTML, social network interface and mobile gaming interface. It shall be noted that although the present invention is implementable in various interfaces, the ensuing example will be explained in the context of basic elements commonly available to each of these interfaces. The act of making such selection comes in the form of invoking a web browser, executing a search at an internet search engine, opening an email at an email client software or another interface. A common feature for each of these acts lies in the ease with which a referendum is presented to the end user. For instance, by invoking a web browser, a web page set as the home page of the web browser is automatically served. A referendum having properties (refID, geoID and keyword) matching those of a request from the web browser is transmitted to client1. In another instance, a search string is entered in an internet search engine and a search request is invoked. The request which contains a geolocation data can be automatically sent as a result of opening the interface or it can be a request that is sent upon clicking a button on the interface. Upon receiving the search request, a server of the internet search engine compares properties (geoID and/or at least one keyword) of the referendum and identifies a referendum matching those of the search request and transmits it along with the search result to the internet search engine at a client system. Therefore, an end user is not required to navigate away from an interface he/she is currently using. In contrast, U.S. Pat. Pub. No. 2007/0192179 discloses a system that is cumbersome to use as a user of such a system is redirected as evidenced in paragraph 19 of the '179 application, thereby discouraging the use of such a survey system:

“Success Criteria—shall mean any criteria defined by the advertiser indicating that a searcher has successfully performed an activity. These activities could be, but are not limited to (i) purchasing something from the advertiser's website (ii) filling out a survey on the advertisers website (iii) seeing the advertisers advertisement or (iv) going to the advertiser's or another sponsored link or website.”

In the '179 application, the user is redirected to an advertiser's website where one or more additional actions are expected.

Referring again to FIG. 1, upon making a referendum selection, a request corresponding to the selection and containing any one or all of the request properties such as refID, geoID and at least one keyword is transmitted to the server 2 (step 26). Upon receiving the request, the software program of the server 2 performs a lookup of a referendum identified by refID, geoID and/or one or more keywords (step 27) and transmits a message representing the referendum associated with at least one of these properties to the interface of the software program of client1 (step 28). In one embodiment, a cookie is incorporated in the message transmitted to and stored (step 30) at the interface. As mentioned elsewhere herein, a message can be treated as having a header portion and a data portion. In one embodiment, the security of a message transmission is further enhanced by encrypting the data portion with a public key. A corresponding private key can be made available at the server such that the data portion of the message can be decrypted. The private key may also be made available to another client given the authority to access the contents of the message. Therefore the additional encryption to the data portion protects the message even if the header portion has been compromised.

Referring back to FIG. 1, the end user may then answer the referendum presented at the interface of the software program (step 32). The step of answering a referendum involves clicking a button presented on the interface. The software program of the interface at client1 then anonymously transmits the referendum result associated with the refID to the server 2 (step 34). Upon receiving the referendum result, the software program of server 2 determines whether to act upon the referendum result (step 36). If parameter countOnce of referendum of refID is set, then the referendum result is stored or tallied and a count associated with the hashed cookie is made available and incremented.

FIG. 1 further depicts the consequence of submitting a referendum result the second time from the same device. The end user answers the referendum presented at the interface of the software program (step 38). The software program of the interface at client1 again anonymously transmits the referendum result associated with the refID to the server 2 (step 40). Upon receiving the referendum result, the software program of server of block 10 again determines whether to act upon the referendum result (step 42). If parameter countOnce of referendum of refID is set and the count associated with a hashed cookie is non-zero, then the referendum result is discarded. This ensures that a referendum result is submitted at most once from one client if so desired. If parameter countOnce of referendum of refID is not set, the referendum is stored or tallied.

A web bot is a software application designed to fetch, analyze and file information from web servers at a much higher rate than would be possible for a human alone. There always exists a possibility where web bots can be adversely used to affect the outcome of the referendums served by the present referendum system. In situations where referendum response contamination by web bots is a concern, a CAPTCHA or Completely Automated Public Turing test to tell Computers and Humans Apart) is used in conjunction with the interface on which a referendum is presented to a human respondent in step 40. Reference is made to U.S. Pat. No. 7,929,805 for an implementation of CAPTCHA, which is incorporated herein by reference in its entirety. In one embodiment, a CAPTCHA is served alongside a referendum that is being served with the referendum displayed in its entirety. In another embodiment, a CAPTCHA is configured to supersede a referendum to be displayed. In the latter embodiment, the referendum is served upon having met the CAPTCHA requirement (such as by entering the required CAPTCHA letters and/or numbers or verification answer and a button click). In use, a CAPTCHA corresponding to a verification answer and requiring a user-entered answer is provided before a referendum result can be transmitted to a server system. Upon receiving a user-entered answer, it is compared to the verification answer. If the user-entered answer matches the verification answer, the referendum result is transmitted to the server system and if the user-entered answer does not match the verification answer, the referendum result is not transmitted to the server system.

The Applicant further discovered that by allowing a respondent of a referendum to access and respond to a referendum only during a specific period of time, the amount of contamination due to web bots can be cut down even without the implementation of CAPTCHA. In use, a user is informed in step 27 of the availability of a referendum and the details for accessing it via a means such as an email, a notification within a secured online environment such as a member area of a social networking service and TV advertisements, and the like. The user can then access the pre-announced referendum at a specified future time period via a specified client interface. The Applicant further discovered that, by restricting access of a referendum to a pre-announced time period, referendum participation is increased in certain circumstances as the limited time period of access to a referendum urges users to take deliberate action to respond to the referendum.

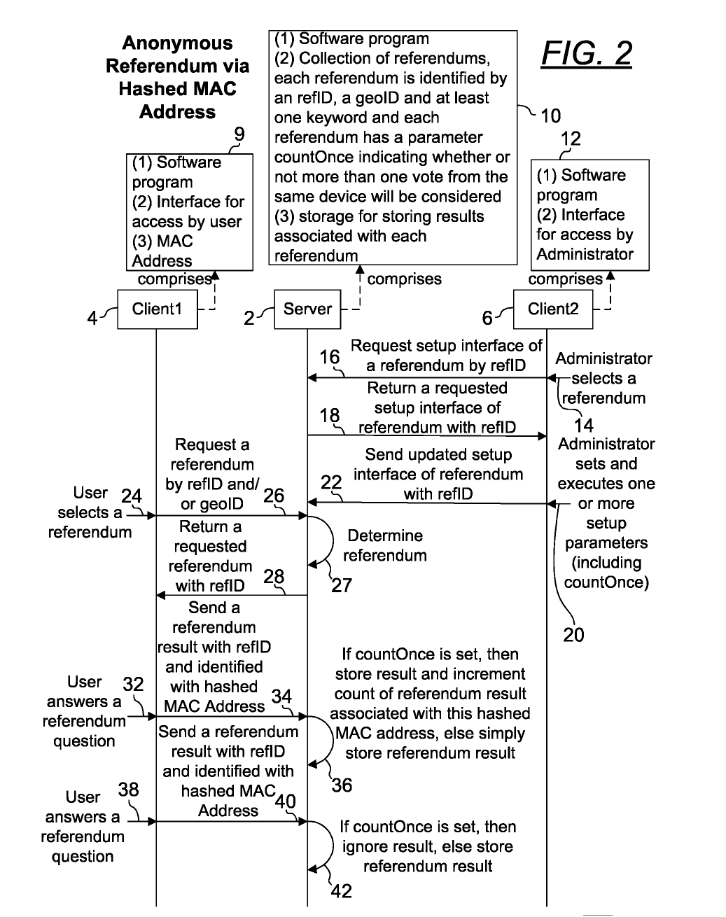

FIG. 2 a sequence diagram depicting the anonymous execution of a referendum using a hashed MAC address. This diagram is essentially the same as FIG. 1 with the exception that a MAC address assigned to a network interface of client1 is used instead of a cookie. In this case, client1 comprises a MAC address as shown in the list of facilities in block 9 of FIG. 2. A hashed MAC address is used primarily in interfaces where other means of generating an identifier is not possible or desired.

In one embodiment, hashing of at least a portion of messages from a client system to a server system is performed according to FIPS 180-3 standards as disclosed in the Federal Information Processing Standards publication regarding Secure Hash Standard (SHS) of October 2008 by National Institute of Standards and Technology.

FIG. 2A depicts a mechanism where a token is used to indicate a client source and a hashed term is used to ensure the integrity of the transmission of a referendum answer from the client source. In this example, the client 4 requests a nonce from the server 2 (step 74). Nonce is defined as “number used once” and it is a random or pseudo-random number issued by the server 2. A nonce is transmitted from the server 2 to the client 4 (step 76). Upon receiving the nonce, the client 4 composes a response (step 78). The response includes referendum as identified by refID, an answer to referendum refID, a token, and a hashed term of the nonce, refID and answer. The token can be a cookie previously transmitted to the client 4 by the server 2 when a referendum was requested. The response is then transmitted from the client 4 to the server 2 (step 80). Upon receiving the response from the client 4, the server 2 may increment the token to indicate a response has been received from the client 4. This token can be used/interpreted to either cause the server 2 to ignore or tally a referendum answer depending on the server configuration which indicates whether or not repeated answer submissions from a client 4 will be considered. Upon receiving the response from the client 4, the server 2 further de-hashes the hashed term to verify the integrity of the transmitted answer (step 82), i.e., if the answer indicated in the response equates that of the answer obtained as a result of de-hashing of the previously hashed term, then the answer is considered reliable and may be used if so desired. The response is authenticated if the de-hashed nonce matches the nonce transmitted by the server 2 to the client 4 earlier. A token is then transmitted from the server 2 to the client 4 to indicate that the response was verified (step 84).

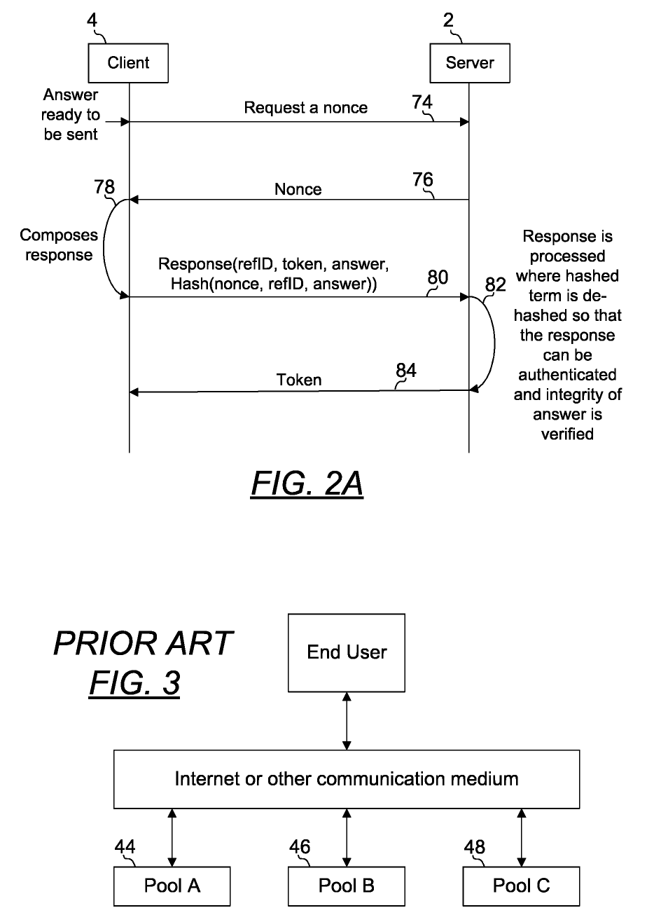

FIG. 3 is a block diagram depicting prior art referendum pools maintained by disparate servers. A total of three referendum pools A, B and C is shown in this example. Each referendum database and the facilities required to administer it are collectively referred to as a referendum pool. An end user may choose to interact via internet or another communication medium with servers for pools A, B and C separately. Each pool has its own list of referendums and is not shared with other pools. For example, each pool may be connected to an online community. A community may be a social network such as Facebook, a professional network such as LinkedIn, a search engine such as Google, a database of a company such as Microsoft and the like. Often times, such databases contain referendum information that by themselves, may not be sizeable to be statistically significant. Statistical data may be used in a number of ways such as for forecasting production volume and enabling focusing of resources on events are the most critical to a company, etc.

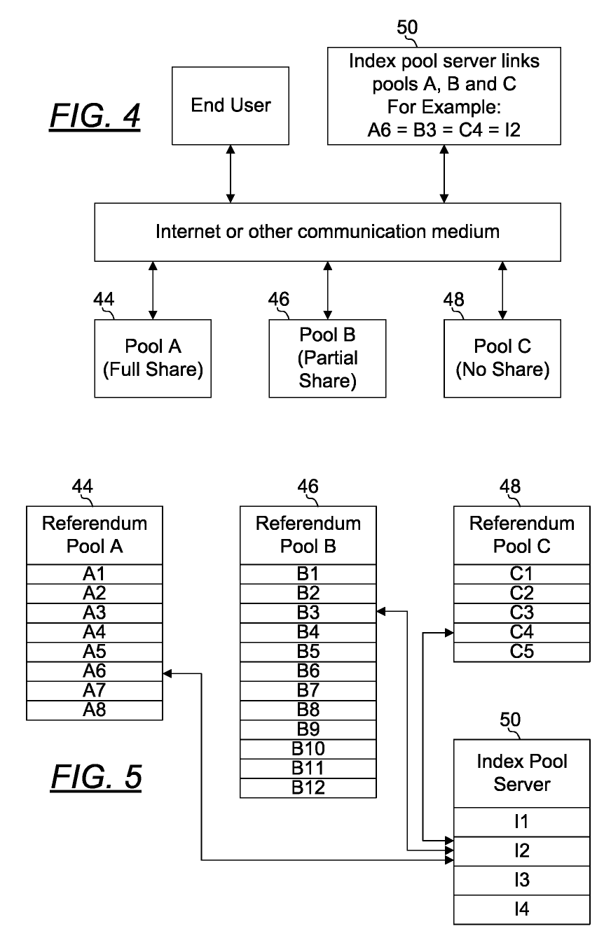

FIG. 4 is a block diagram of the present invention depicting a mechanism by which referendum pools of disparate servers are shared. The Applicant discovered a novel mechanism that facilitates sharing of referendum results from disparate pools. An index pool server 50 is provided to receive and process referendum proposals from various referendum pools and reconcile them before adding them to a global list. Each pool may alternatively be configured to be fully shared, partially shared or not shared. In a full share situation, all referendums within a pool is shared with the index pool server 50 and other pools which in this example A, B and C that are connected within the network. In this example, pool A is configured to fully share its referendums and their corresponding results, pool B is configured to partially share its referendums and their corresponding results and pool C is configured to not share any of its referendums. The sharing of referendums within a referendum pool may alternatively be configured at the referendum level, i.e., each referendum may contain a switch to specify whether or not its creation and collected results will be shared with other referendum pools and the index pool server 50.

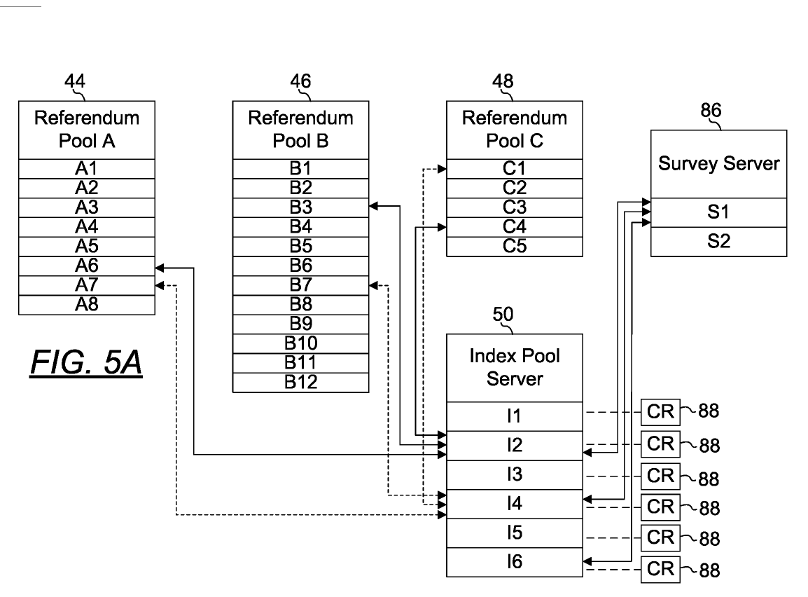

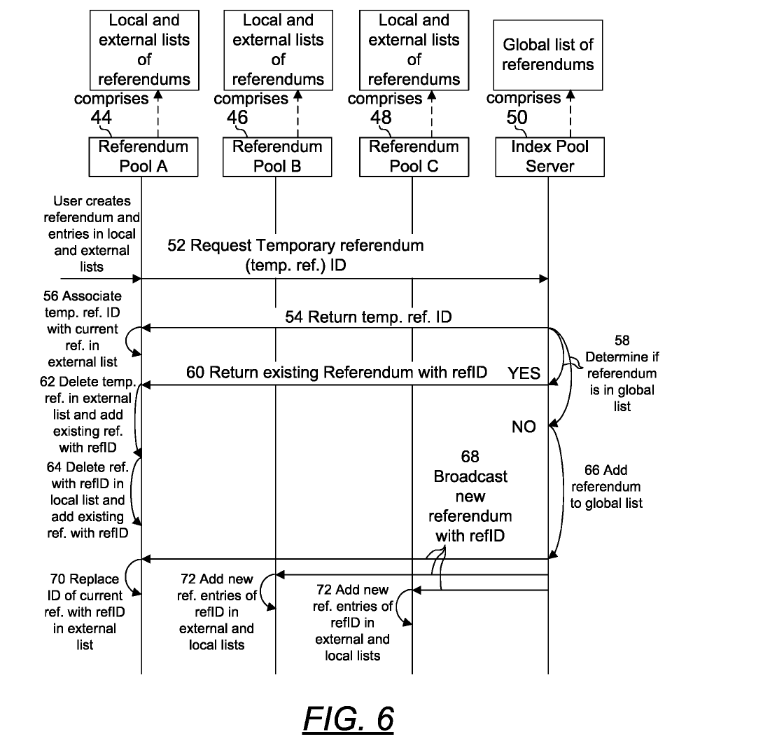

FIG. 5 is a block diagram of the present invention depicting referendum pools 44, 46, 48 of disparate servers that are linked to an index pool server 50. Each pool maintains its own list. For example, referendum A6 of pool A 44, referendum B3 of pool B 46, referendum C4 of pool C 48 are shown to be equivalent and they are represented as referendum 12 in the index pool server 50. FIG. 6 is a sequence diagram depicting a synchronization process of a plurality of referendum pools using a mechanism according to the present invention. Each referendum pool 44, 46, 48 includes an external list and a local list. A local list is used to track all referendums created, utilized or maintained within a pool. An index pool server 50 is provided to facilitate creation of referendums from referendum pools which subscribe to its service and maintain a global list of referendums. An external list of a current referendum, on the other hand, contains referendums created in the current referendum pool or any referendums created in other referendum pools but shared with the current referendum pool.

FIG. 5A is a block diagram of the present invention depicting a survey server 86 that is linked to the index pool server of FIG. 5. In this example, the survey server 86 contains surveys S1 and S2 which are essentially supersets of referendums. The Applicant discovered that the concept of utilizing an index pool server 50 to standardize referendums from different pools A, B and C is made possible only by using referendums as they represent the most rudimentary opinion solicitation means. In this example, survey S1 is linked to referendums I2, I4 and I6 of the index pool server 50. Therefore I2, I4 and I6 are called linked members of survey S1. An administrator can choose to display these referendums one at a time or all at the same time. In the case where multiple referendums are displayed at once, an additional button is provided to a user in order to effectuate submission of one or more answers of the referendums to the administrator. In the case where one referendum is displayed at one time, a set of criteria 88 is further provided to each referendum in the index pool server 50. Upon serving the first referendum, the ensuing referendum/s are served or displayed based on the answer provided to the first referendum or the referendum preceding it. If the number of referendums having all of their criteria met exceeds one, the referendums are displayed in a random order. Any referendum linked to a member of the survey server will only be served if all criteria have been met. Therefore, only suitable referendums which are the most relevant to the interests of a user are served in a survey. As an example, referendums I2, I4 and I6 represent the following respectively:

I2: What color do you like for your car, dark or light?

Choice 1: Dark.

Choice 2: Light.

I4: Do you prefer “Obsidian Black” to “Jet Black?”

Choice 1: Yes.

Choice 2: No.

I6: Do you prefer “Pearl White” to “Metallic White?”

Choice 1: Yes.

Choice 2: No.

I4 is configured to include only one criterion and the criterion is “Dark” while I6 is configured to also include only one criterion and the criterion is “Light.” Assuming I2 is selected as the starting referendum and if the answer to I2 is Choice 1, I4 will be selected. If Choice 2 of I2 is selected, I6 will be served instead.

In the context of a survey having two or more linked members, upon receiving a request for referendums, the present referendum system serves the very first referendum of the survey based upon the method an unlinked referendum is served, as it was disclosed elsewhere herein. In one embodiment, the ensuing referendums of the survey are served based on the concept of matching the criteria of a current referendum and the response to a previously served referendum. In another embodiment, the referendums of a survey are placed in a prefixed order and served based on a time schedule. Referring back the example of FIG. 5A, lacking a user response, referendums I2, I4 and I6 can each be served for a prefixed period of time in the order of I2, I4 and I6. The Applicant discovered that by cycling referendums in a survey, its participation can be significantly improved.

Referring to FIG. 6, a user first creates a referendum with a local identifier in the external and local lists of referendum pool A. As a result, a request for a temporary referendum identifier is transmitted from referendum pool A to the index pool server 50 (step 52). The index pool server 50 then returns a temporary referendum identifier to referendum pool A (step 54). Referendum pool A then associates the temporary referendum identifier with the current referendum in the external list of referendum pool A (step 56). The index pool server 50 then determines if the current referendum is equivalent to a member of the global list by comparing the current referendum to all members of the global list (step 58). In one embodiment, step 58 is performed by comparing keywords of the current referendum to keywords of all members of the global list. In another embodiment where keywords comparison leaves ambiguity as to the equivalence of the current referendum and any member of the global list, a manual comparison is performed. If the current referendum is equivalent to a member of the global list, the member is transmitted to referendum pool A (step 60). The temporary referendum identifier and the current referendum are deleted from the external list of referendum pool A (step 62). The current referendum is deleted from the local list of referendum pool A and the member is added to the local and external lists of referendum pool A (step 64).

If the current referendum is not equivalent to any member of the global list, the current referendum is added to the global list (step 66). The current referendum is broadcast to the plurality of referendum pools B, C (step 68). The local identifier of the current referendum is replaced with the global identifier of the current referendum (step 70). The current referendum is added to all external and local lists of the other referendum pools of the plurality of referendum pools B,C (step 72). Upon completing step 72, all referendum pools that subscribes to the index pool server 50 now includes the new referendum created in referendum pool A and a common ID, i.e., which references the new referendum.

The following example illustrates a situation where manual deliberation may be required. Referendum 1: “Would you vote for Prime Minister Julia Gillard in 2014? Yes or No”

Referendum 2: “Re-elect Prime Minister Julia Gillard in 2014? Yes or No”

Although Referendums 1 and 2 share several keywords, manual deliberation may be required to ensure that the two referendums are equivalent.

As a second example, consider the following referendum:

Referendum 3: “I will not vote for Prime Minister Julia Gillard in 2014? Yes or No”

Logically, Referendum 3 is the inverse of Referendums 1 and 2. In one embodiment, an inverse operator may be applied to Referendum 3 to produce an equivalent referendum such as Referendum 1 or 2.

The benefit of the present method of sharing referendum information across multiple referendum pools becomes apparent for referendums in different languages.

As a third example, consider the following referendum:

Referendum 4: “ [symbol] Quieres votar por el Primer Ministro Julia Gillard en 2014? Si o No”

Referendum 4, which is expressed in Spanish, can be translated to a phrase that is equivalent to Referendums 1 or 2. The benefits of the ability to link referendums of various referendum pools become apparent when such linkages increase the size of a referendum pool to include other referendum pools subscribing to the same index pool server.

In the context of an internet search engine, the present referendum system cooperates with internet search engines to improve search results. One key component affecting the presentation of a search result (such as web position) is the popularity of a web page. One key component affecting the popularity of a web page lies in the number of quality clicks it receives. Although various internet search engines may define their quality clicks differently, most are configured to treat clicks from human users as quality clicks while clicks from robotic users are frowned upon. It is contemplated by the present invention that a robotic user may be any non-human operator (i.e., an internet bot, web bot program, virus, robot, web crawler, web spidering program, or any software applications that run automated tasks over the Internet), which is an artificial agent that, by its actions, conveys a sense that it has intent or agency of its own. A human user is contemplated as being a human, but also, an entity (virtual or physical) acting under the present intent of a human operator. Typically the web position of a web page is proportional to the number of quality clicks it receives. The present referendum system provides referendums that may be presented as results of an internet search. As a content enhancer, a referendum is served alongside main contents of a web page. The referendum aids in the web position of the web page by serving as a means to verify that the user of the web page is a human user. By providing an interface for human user interactions, the present referendum system allows the use of the referendum as a means for an internet search engine to tally quality clicks. Further, an internet search engine may further utilize the results of referendums to determine the web position of a web page. For instance, a web page associated with a referendum having a higher number of votes may be web positioned more favorably than a referendum that garners a lower number of votes.

More specifically, the internet search engine includes a search method for determining the web position of a referendum relative to other web pages indexed by the internet search engine. The search method first indexes the referendum. The search method then determines the number of quality clicks the referendum received before normalizing it to a normalized value. A normalized value indicates the degree of relevance of an indexed web page as compared to a search target of an internet search and it may include factors such as the number of quality clicks to a web page, the amount of changes to a web page over a period of time, the number of highly ranked incoming links and the like. The search method then compares the normalized value to normalized values corresponding to the other web pages indexed by the internet search engine. If the normalized value is higher than the normalized value corresponding to at least one of the other indexed web pages, the referendum is assigned a more favorable web position relative to the at least one of the other indexed web pages. If the normalized value is lower than the normalized value corresponding to at least one of the other indexed web pages, the referendum is assigned a less favorable web position relative to the at least one of the other indexed web pages.

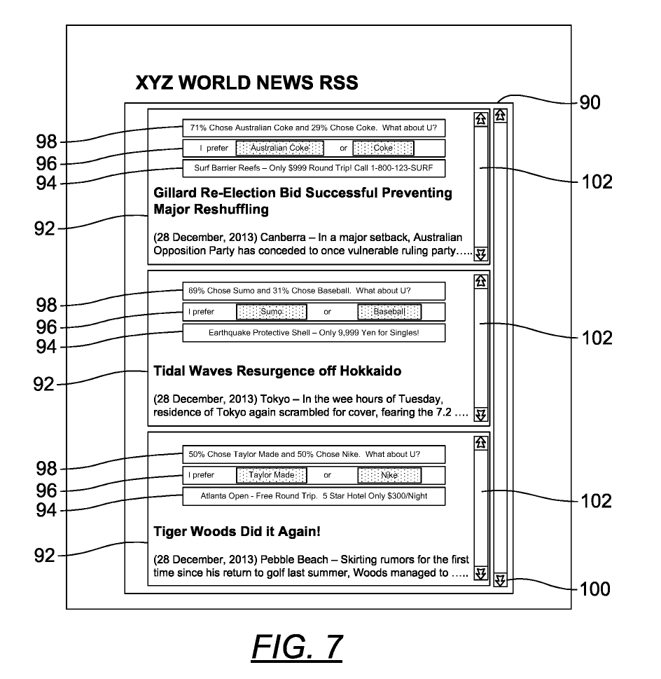

FIG. 7 is a display depicting the presentation of a referendum on a subscription based application. As used herein, a subscription based application can be any publish-subscribe system where a user can decide to add or subscribe to a published content or to remove the subscribed content. Exemplary publish-subscribe systems include, but not limited to, RSS, IRC, Atom, microblogs and SMS (Short Message Service) or texting service. Current internet or web publish-subscribe systems such as RSS and Atom enable users to subscribe to selected information from various web sources. Current commercial embodiments of subscription based applications include, but not limited to, newsfeeds from Reuter, e.g., http://feeds.reuters.com/reuters/businessNews, microblogs facilitator such as Twitter, and the like. Further, an exemplary RSS system is disclosed in U.S. Pat. Pub. No. 2007/0156809. Said patent disclosure is incorporated by reference in its entirety. As RSS files are essentially Extensible Markup Language (XML) formatted plain text, the RSS file itself is relatively easily read both by automated processes and by humans alike. XML formatted plain text could be placed on any appropriate communication protocol for file retrieval, such as Hypertext Transfer Protocol (HTTP) or file transfer protocol (FTP), and reading software would use the information to present a neat display to the end user.

Referring to FIG. 7, an RSS entitling “XYZ WORLD NEWS” is shown with subscription based content 90 or feed. In this example, three articles 92 or summary details of website content, such as news items, are displayed. Three banners including an advertisement banner 94, a referendum banner 96 and referendum result 98, are presented along with each article 92. An article scroll bar 102 is made available to each article 92 such that each article can be compressed to take up only a small portion of a display while allowing the user to read the article with the aid of a scroll bar 102. In one embodiment, each of the banners 94, 96, 98 is fixedly displayed as each article is scrolled. In another embodiment, each banner scrolls with article, therefore disappearing from view as the article is scrolled towards its end. Applicant discovered that by disposing a referendum in a targeted area such as in a subscription based application, viewership of the referendum is increased as compared to referendums in non-targeted areas.

Applicant discovered there are at least three factors affecting the increased effectiveness of serving referendums in a subscription based applications. A referendum may be served based on a geoID and keywords relevant an article. For instance, the geoID of a referendum belonging to a referendum pool server is compared against the location associated with a router through which an HTTP request is routed. If the geoID matches a property associated with the location of the router, the referendum is considered relevant in terms of its proximity to the display on which the subscription based application is run. As an example, in the article “Tidal Waves Resurgence off Hokkaido,” the selection of the referendum: “I prefer Sumo or Baseball” may be based on an HTTP request that originates in Japan as Sumo is a uniquely Japanese sport. In this example, the geoID associated with a referendum may have only played a partial role in causing the referendum to be selected as the text of the article may also have provided keywords which are considered relevant to the referendum as Hokkaido is the name of an island in Japan. In this example, an advertisement banner 94 is displayed alongside an article 92 to further maximize the opportunity to advertise to users of the subscription based content 90. In this example, a referendum statistics banner 98 is displayed to further entice the user to vote as the display of referendum statistics banner 98 creates urgency in the part of the user to either strengthen or change the outcome of the referendum statistics. If the user feels strongly about baseball and desires to change the outcome of the banner that reads “69% Chose Sumo and 31% Chose Baseball. What about U?,” the user will most likely select the answer “Baseball” in order to cause an uptrend in the percentage vote associated with Baseball. A referendum statistics banner 98 has been found to improve participation in its corresponding referendum. If an article looks interesting to the user, the user can click on the article 92 or a link 106 provided within the article 92 to go to the originating website of the article 92 and read the full article. Similarly, the user can click on the referendum banner 96 or a link 104 to go to the originating website of the referendum 96 and read the referendum as presented within the context of the originating website. One notable feature of the present system deals with the ability to urge users to engage in the subscription based content. As the subscription based content is time limited, i.e., new feeds are provided periodically, the users feel more compelled to engage in reading feeds and interact with the referendums or advertisements.

Another notable feature of the present system deals with the means by which a subscription based content is engaged. Typically, a feed is manually selected by a user who finds a subject interesting. Alternatively, a user may automatically be presented with a feed as a result of having entered a code identifying a feed source. The code includes a quick response (QR) code, barcode or other non-text coding means. The code may also indicate a privilege granted as a result of making the purchase of a service, goods, etc. For instance, a code may be provided on a sports game or concert ticket such that a feed source can be arranged to provide a feed along with a referendum.

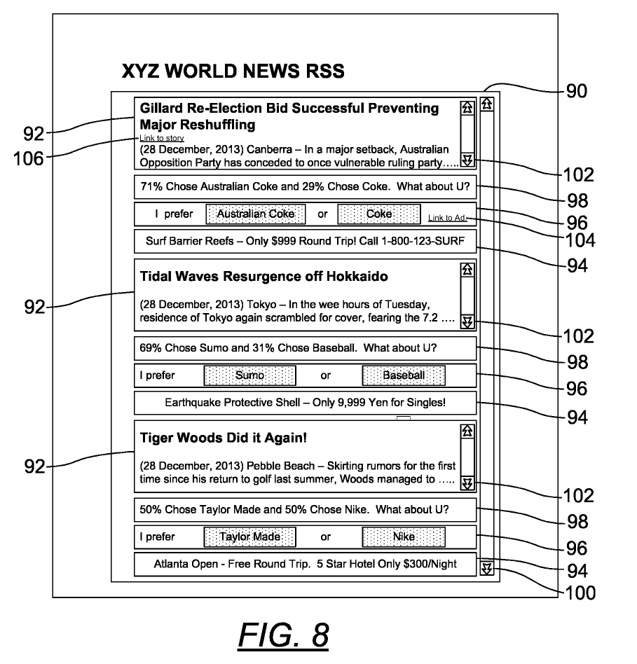

FIG. 8 is a display depicting the presentation of a referendum on a subscription based application. In this instance, the presentation of banners 94, 96, 98 is segregated from an article 92 but is made in close proximity to the article 92. In its displayed state, each referendum is displayed in a manner where the user is incapable of discerning the referendum from the article as two separate entities, thereby lowering the chance that the referendum will be ignored. In this case, the banners 94, 96, 98 are disposed immediately after an article 92 and each may be treated as an “article” of the feed. In this instance, the provider of subscription based content (e.g. article 92) is relieved from the responsibility of the banners 94, 96, 98. The responsibility to present the banners 94, 96, 98 rests on the subscription based application provider. The subscription based application provider may not need to seek permission from the subscription based content provider to enable at least one of the banners 94, 96, 98. As presented in FIG. 7 and in contrast to FIG. 8, the decision to enable at least one of the banners 94, 96, 98 is based an agreement or an interface between the owner/s of the subscription based content and the subscription based application provider.

I claim:

1. A system of conducting a referendum, said system comprising:
(a) a subscription based application having a content; and
(b) a referendum having at least one attribute relevant to said content and wherein said referendum is presented in close proximity to said content within said subscription based application.

2. The system of claim 1, further comprising an advertisement banner served within said subscription based application.

3. The system of claim 1, further comprising a referendum statistics banner served within said subscription based application.

4. The system of claim 1, wherein said subscription based application comprises XML formatted plain text.

5. A method of conducting a referendum anonymously, said method comprising the steps of:
(a) transmitting a request from a client system to a server system, wherein said request comprises at least one user specific data and said client system is a subscription based application;
(b) determining a referendum as identified by a referendum identifier and corresponding to said at least one user specific data of said request;
(c) returning said referendum from said server system to said client system;
(d) transmitting a referendum result from said client system to said server system via a message having a header portion and a data portion, wherein said header portion comprises a unique identifier identifiable to said server system as originating from a source but not identifiable with respect to the true identity of said client system;
(e) comparing said unique identifier to a list of unique identifiers, whereby if said unique identifier does not match a member of said list of unique identifiers, said referendum result is added to a database relating said referendum to a list of referendum results and if said unique identifier matches a member of said list of unique identifiers, said referendum result is discarded; and
(f) adding said unique identifier to said list of unique identifiers.

6. The method of conducting an anonymous referendum of claim 5, said subscription based application is selected from a group consisting of Really Simple Syndication (RSS), Internet Relay Chat (IRC), microblogs and Short Message Service (SMS).

7. The method of conducting an anonymous referendum of claim 5, wherein said subscription based application comprises XML formatted plain text.

8. The method of conducting an anonymous referendum of claim 5, wherein said at least one user specific data comprises geolocation data.

9. The method of conducting an anonymous referendum of claim 5, wherein said at least one user specific data comprises at least one keyword.

10. The method of conducting an anonymous referendum of claim 5, wherein said unique identifier comprises an entity selected from a group consisting of hashed cookie and hashed MAC address.

11. The method of conducting an anonymous referendum of claim 5, wherein the transmitting step of the referendum result further comprises the steps of:
(a) providing a CAPTCHA corresponding to a verification answer, said CAPTCHA requiring a user-entered answer; and
(b) receiving a user-entered answer, whereby if said user-entered answer matches said verification answer, said referendum result is transmitted to said server system and if said user-entered answer does not match said verification answer, said referendum result is not transmitted to said server system.

12. The method of conducting an anonymous referendum of claim 5, wherein said data portion is configured to be encrypted with a public key and decoded with a private key.

13. The method of conducting an anonymous referendum of claim 5, wherein an advertisement banner is served within said client system.

14. The method of conducting an anonymous referendum of claim 5, wherein a referendum statistics banner is served within said client system.

15. A system of conducting at least one referendum anonymously, said system comprising:
(a) a storage to store a result associated with said at least one referendum;
(b) at least one server system to serve said at least one referendum over a network to a subscription based application;
(c) at least one client system to transmit a referendum result of said at least one referendum to said server system via a message including a header portion and a data portion, said header portion comprising a unique identifier identifiable to said server system as originating from a source but not identifiable with respect to the true identity of said at least one client system; and
(d) a software program to compare said unique identifier to a list of unique identifiers, whereby if said unique identifier does not match a member of said list of unique identifiers, said referendum result is added to said storage and if said unique identifier matches a member of said list of unique identifiers, said referendum result is discarded.

16. The system of claim 15, wherein said at least one client system further comprises an index pool server configured to index said at least one referendum from said at least one server system such that said at least one referendum can be shared with another server system of said at least one server system.

17. The system of claim 15, wherein said at least one client system further comprises a survey server configured to link said at least one referendum and another one of said at least one referendum to form one or more surveys.

18. The system of claim 15, wherein said data portion is configured to be encrypted with a public key and decoded with a private key.

19. The system of claim 15, further comprising a referendum statistics banner served within said subscription based application.

20. The system of claim 15, wherein said subscription based application comprises XML formatted plain text.
